(19) United States
(12) Patent Application Publication
(10) Pub. No.: US 2007/0154053 A1
(43) Pub. Date: Jul. 5, 2007

(54) RESONANCE CHAMBER OF MOBILE PHONE

(75) Inventor: TSUNG-LUNG YANG, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/560,777

(22) Filed: Nov. 16, 2006

(30) Foreign Application Priority Data
Jan. 3, 2006 (CN) 200610032626.6

(51) Int. Cl. H04R 1/02

(52) U.S. Cl. 381/386

(57) ABSTRACT

A resonance chamber of mobile phone includes a shell (11) defining a resonance cavity (20) for receiving a speaker (50) therein. A plurality of holes (18) is defined in the shell facing to a first side of the speaker. A channel (30) is defined in the shell extending laterally from a second side opposite to the first side of the speaker and communicating with the resonance cavity. An opening (40) is defined in the shell to communicate the channel with the environment. The channel has a width and a length smaller than a wavelength of an acoustic wave generated by the speaker.

### BACKGROUND OF THE INVENTION

1. Field of the Invention

The present invention relates generally to a resonance chamber of a mobile phone, and more particularly to a resonance chamber with improved resonance in low frequency voices.

2. Description of Related Art

Sound is the most important means by which people communicate with each other, and so creating new methods for sound transference allows greater communication between people. Electroacoustic transducers are key components in transferring sound. A typical electroacoustic transducer has a magnetic circuit in which a magnetic field generated by a magnet passes through a base member, a magnetic core and a diaphragm and returns to the magnet again. When an oscillating electric current is supplied to a coil wound around the magnetic core, the corresponding oscillating magnetic field generated by the coil is then superimposed onto the static field of the magnetic circuit. The resulting oscillation generated in the diaphragm is then transmitted to the air as sound. The basic loudspeaker, in which electric energy is converted to acoustic energy, is a typical electroacoustic transducer. There are many different types of loudspeakers, including electrostatic loudspeakers, piezoelectric loudspeakers, and moving-coil loudspeakers.

Nowadays, mobile phones are widely used and loudspeakers are important components used with mobile phones. In an inner space of the mobile phone, a resonance chamber can be used to generate acoustic messages. As design style for mobile phones emphasizes lightness, smallness, energy-efficiency, and low cost, the inner space available for loudspeakers within mobile phones is therefore limited. Thus the size of the resonance chamber is restricted mainly by the size of the mobile phone. However, as the mobile phone becomes slimmer, the resonance effect of low frequency voices is reduced due to the reduced size of the resonance chamber.

Therefore, enhancement of the resonance effect of the resonance chamber without changing the size of the mobile phone has become an important issue in improving voice quality of the mobile phone.

### SUMMARY OF THE INVENTION

According to a preferred embodiment of the present invention, a resonance chamber of a mobile phone includes a shell defining a resonance cavity for receiving a speaker therein. A plurality of holes are defined in the shell facing towards a first side of the speaker. A channel is defined in the shell extending laterally from a second side of the speaker opposite the first side thereof, and communicating with the resonance cavity. An opening is defined in the shell communicating the channel with the outside environment. The channel has a length and a width which is much smaller than the wavelength of the acoustic wave generated by the speaker, and a volume of the channel is much smaller than that of the resonance cavity.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric view of a mobile phone in accordance with a preferred embodiment of the present invention;

FIG. 2 is a schematic view of a first embodiment of a resonance chamber of the mobile phone of FIG. 1;

FIG. 3 is a schematic view of a typical Helmholtz resonance chamber;

FIG. 4 a schematic view of an alternative embodiment of the resonance chamber; and

FIGS. 5-8 show simulated test results of resonance frequency of the resonance chamber of FIG. 4.

### DETAILED DESCRIPTION OF THE INVENTION

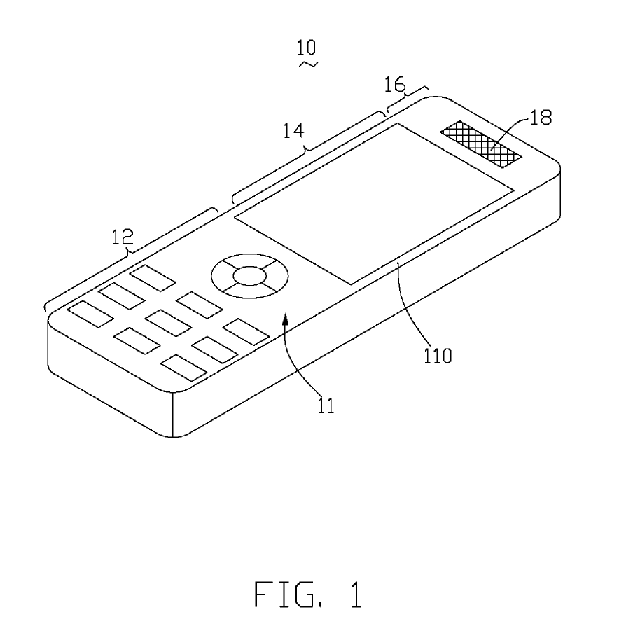

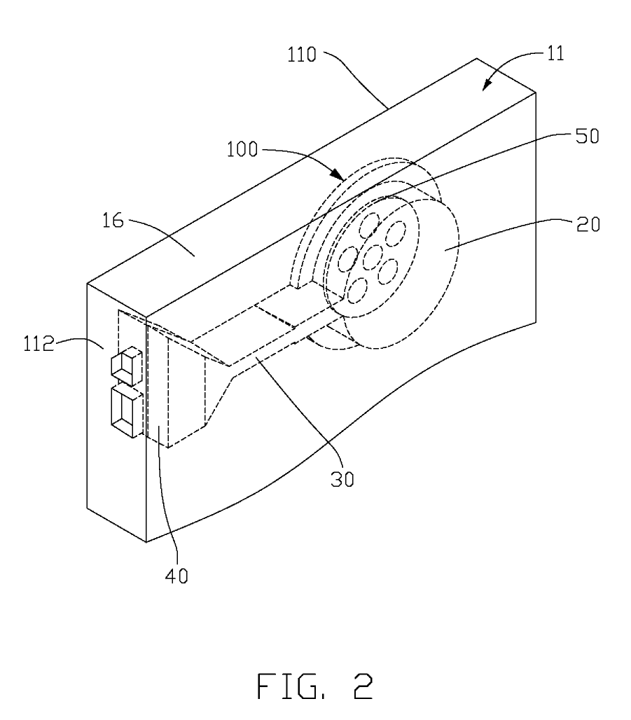

FIG. 1 shows an isometric view of a mobile phone 10 having a cuboid-shaped shell 11 defining an inner space therein for receiving components, such as PCB (printed circuit board), antenna, battery, and so on. The shell 111 includes an output section 16, a display section 14, and an input section 12. The input section 12 has a plurality of keys (not labeled) or a touch panel (not shown) for inputting signals arranged on a front side 110 of the shell 11. The output section 16 of the mobile phone 10 receives a speaker 50 (FIG. 2) which can transform electric signals into mechanical vibrations so as to transmit acoustic messages therein. The speaker 50 has a magnetic circuit in which a magnetic field generated by a magnet passes through a base member, a magnetic core having coil wound thereon, and a diaphragm. A plurality of holes 18 are defined in the front side 110 of the output section 16 of the shell 111 positioned corresponding to the section of the front side 110 closest to the speaker 50, thus allowing transmission of acoustic messages outwardly therethrough.

As shown in FIG. 2, a resonance chamber 100 which is indicated by the broken line is defined in the inner space of the output section 16. The resonance chamber 100 includes a resonance cavity 20, and a channel 30 communicating with the resonance cavity 20. The resonance cavity 20 is column-shaped, including two opposite side surfaces and a cylinder interconnecting the two side surfaces. The two side surfaces are parallel to the front side 110 of the shell 11, whilst the cylinder is oriented perpendicular to the front side 110 of the shell 11. A diameter of the resonance cavity 20 is approximately the same or a little larger than that of the speaker 50. The speaker 50 is thus received in the resonance cavity 20 and is placed on the front side 110 just behind the holes 18 of the shell 11. The holes 18 face a front side of the speaker 50. The channel 30 extends generally perpendicularly and laterally from the cylinder of the resonance cavity 20 to a lateral side 112 of the output section 16 of the shell 11, and defines an opening 40 in the shell 11. The resonance cavity 20 thus communicates with the environment through the channel 30. In addition, the channel 30 extends from a rear side of the speaker 50. The opening 40 of the shell 11 extends along the extending direction of the channel 30 from a distal end of the channel 30 to an outer periphery of the shell 11. In this embodiment, the opening 40 is defined in the left side of the shell 11. Alternatively, the opening 40 can be defined in any side of the shell 11, such as right side or rear side of the shell 11, etc. The channel 30 is approximately cuboid-shaped. A cross section of the channel 30 is approximately rectangle-shaped. A length and a width of the channel 30 are much smaller than the wavelength of the acoustic wave generated by the speaker 50, and a volume of the channel 30 is much smaller than that of the resonance cavity 20. The resonance chamber 100 is thus configured as a Helmholtz resonance chamber.

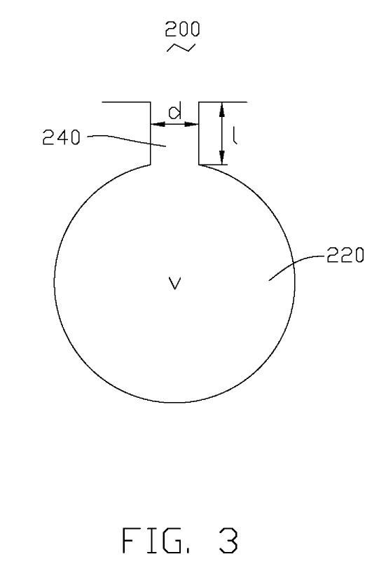

FIG. 3 shows a typical Helmholtz resonance chamber 200, which is widely applied to simulate frequency responses of a speaker system. As shown, the Helmholtz resonance chamber 200 is a rigid-wall cavity 220 with a narrow, short neck 240 communicating the cavity 220 with the environment. The diameter and length of the neck 240 is much smaller than the wavelength of the acoustic wave, the air inside the neck 240 can thus be regarded as a massive block. Moreover, as the volume inside the chamber is much larger than that in the neck 240, the air inside the resonance chamber 200 presents a quasi spring-and-damper structure. Thus, when the frequency of the acoustic wave equals the natural frequency of the resonance chamber 200, the quasi massive-block inside the neck 240 would be actuated to vibrate in a predetermined pattern. The actuated quasi massive-block would simultaneously contact the sidewall of the neck 240 so as to dampen down the dynamical motion thereof.

According to Temkin's equation, vibration frequency f of the Helmholtz resonance chamber 200 is:

f=(c/2π)*[S/(V*I′)]^{0.5}. In which c stands for the speed of the sound in meters per second, S stands for the opening size of the neck 240 in square meters; V stands for the volume of the resonance chamber 200 in cubic meters; and I′ stands for an effective length in meters. Where the cross section of the neck 240 is circular, I′=I+0.8 d, in which I is the length of the neck 240 in meters and d is a diameter of the cross section of the neck 240 in meters. It is clearly that, as the size of the resonance chamber 200 increases, the effective resonance frequency is lowered. The size and shape of the neck 240 and cavity 220 decide the resonance frequency of the resonance chamber 200.

During communication of the mobile phone 10, the speaker 50 transforms electric signals into mechanical vibration of the diaphragm thereof to generate sound. When an oscillating electric current is supplied to the coil wound around the magnetic core, a corresponding oscillating magnetic field is thus generated by the coil and is then superimposed onto the magnetostatic field of the magnetic circuit, resulting in oscillation being generated in the diaphragm of the speaker 50. When the oscillation frequency of the diaphragm in the resonance cavity 20 is equal to the natural frequency of resonance chamber 100, the air of the resonance cavity 20 is actuated in a predetermined pattern. The air in the channel 30 of the resonance chamber 100 is thus actuated to vibrate, and the air of the environment near the opening 40 is actuated to vibrate thus generating sound.

For the resonance cavity 20 communicating with the environment through the channel 30, the pressure of the air in the resonance cavity 20 is approximately the same as that of the environment. The differential pressure between the resonance cavity 20 and the environment is nearly zero. The deformation of the diaphragm is not as limited as the diaphragm of a conventional mobile phone which has a resonance chamber 100 not communicating with the environment. Thus the maximum deformation displacement of the diaphragm increases, and the length of stroke of the diaphragm increases. A volume of the air actuated by the diaphragm, which is the product of the length of stroke of the diaphragm and the area of the diaphragm, is thus increased. The SPL (sound pressure level) of low frequency of the sound is directly proportional to the volume of the air actuated by the diaphragm. Thus the resonance effect of the speaker 50 of the present invention at low frequencies is improved.

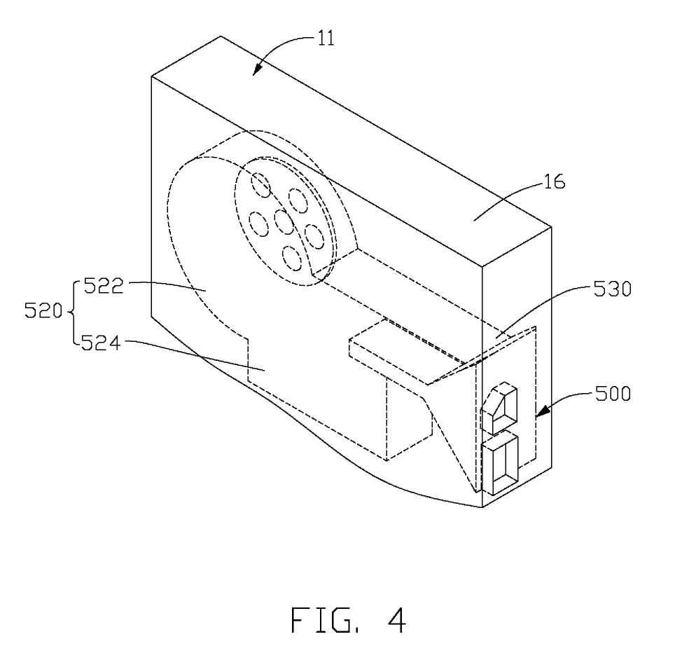

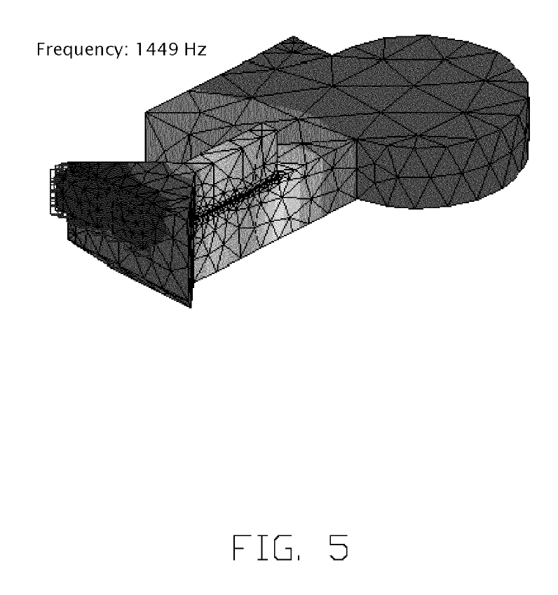

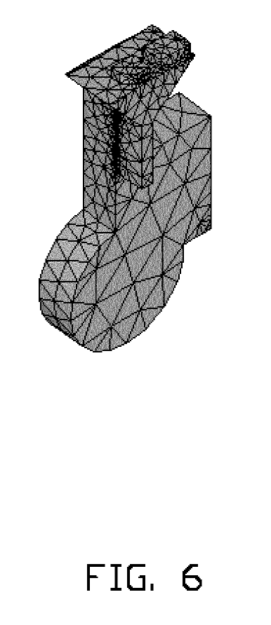

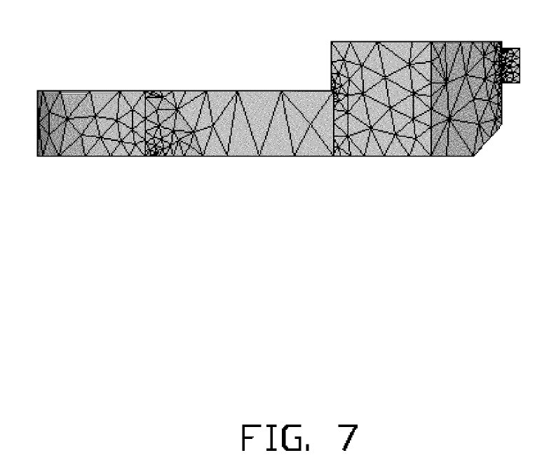

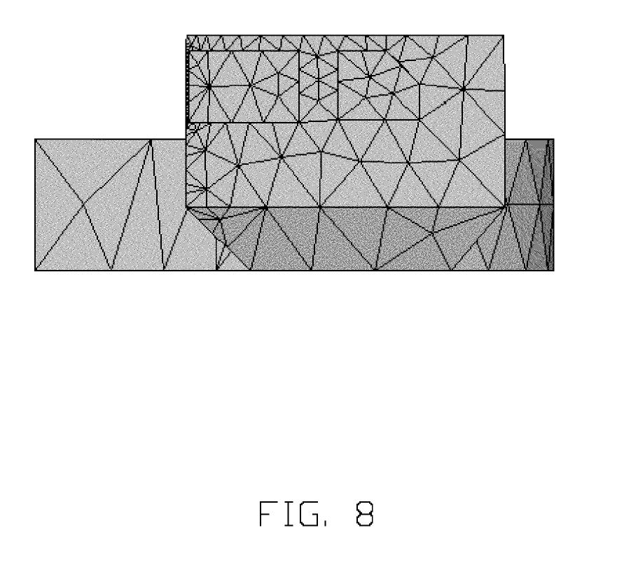

FIG. 4 shows an alternative embodiment of the resonance chamber 500. Also the resonance chamber 500 is defined in the output section 16 of the shell 11, and includes a resonance cavity 520 and a channel 530 communicating with each other. The distal end of the channel 530 communicates with the environment. The difference between this embodiment and the previous embodiment is that the resonance cavity 520 is irregularly shaped. The resonance cavity 520 comprises a first portion 522 which is column-shaped and a second portion 524 which is cuboid-shaped. The first and second portions 522, 524 of the resonance cavity 520 are partly overlapped and communicate with each other. FIGS. 5-8 show simulation results of resonance frequency of the resonance chamber 500. The density of the lines reflects the SPL of the sound. As shown, the resonance frequency of the resonance chamber 500 is about 1449 Hz. Understandably, the shape and size of the resonance cavity 20, 520 and the channel 30, 530 can be changed according to the lowest resonance frequencies of a mobile phone used. For example, the channel 30 (530) can be column-shaped with a circular-shaped cross section. Alternatively, the channel 30 (530) can be a triangular prism with a triangle-shaped cross section.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A resonance chamber of a mobile phone, comprising:
a shell defining a resonance cavity for receiving a speaker therein;
a plurality of holes being defined in the shell facing towards a first side of the speaker;
a channel being defined in the shell, the channel extending laterally from a second side opposite to the first side of the speaker and communicating with the resonance cavity; and
an opening being defined in the shell to communicate the channel with the environment.

2. The resonance chamber of claim 1, wherein the channel is column-shaped with a circular-shaped cross section.

3. The resonance chamber of claim 1, wherein the channel is cuboid-shaped with a square-shaped cross section.

4. The resonance chamber of claim 1, wherein the channel is a triangular prism with a triangle-shaped cross section.

5. The resonance chamber of claim 1, wherein the resonance cavity is column-shaped, the channel extending from a cylinder of the resonance cavity.

6. The resonance chamber of claim 1, wherein the resonance cavity is irregularly shaped.

7. The resonance chamber of claim 6, wherein the resonance cavity includes a cuboid-shaped portion and a column-shaped portion communicating and overlapping partly with each other.

8. A mobile phone comprising:
a shell comprising:
an input section for inputting signals therein; and
an output section defining a resonance chamber therein and an opening in a side thereof which communicates with the environment, the resonance chamber comprising a resonance cavity, and a channel having two opposite ends communicating with the resonance cavity and the opening, respectively; and
a speaker being received in the resonance cavity for transforming electric signals into mechanical vibrations so as to generate sound.

9. The mobile phone of claim 8, wherein a cross section of the channel has one of the following shapes: circular, square and triangular.

10. The mobile phone of claim 8, wherein the resonance cavity is column-shaped, the channel extending from a cylinder of the resonance cavity.

11. The mobile phone of claim 8, wherein the resonance cavity is irregular-shaped, including a cuboid-shaped portion and a column-shaped portion communicating and overlapping partly with each other.

12. The mobile phone of claim 8, wherein a plurality of holes are defined at a location close to the speaker at a first side thereof, and the opening is defined in the shell at the side opposite to or perpendicular to the side in which the holes are defined.

13. A mobile phone comprising:
a shell comprising:
an input section for inputting signals therein; and
an output section defining a resonance chamber therein and an opening in a side thereof which communicates with the environment, the resonance chamber comprising a resonance cavity, and a channel having two opposite ends communicating with the resonance cavity and the opening, respectively; and
a speaker being received in the resonance cavity for transforming electric signals into mechanical vibrations so as to generate sound;
wherein a transverse size and a lengthwise size of the channel are smaller than a wavelength of an acoustic wave generated by the speaker.

14. The mobile phone of claim 13, wherein a volume of the channel is smaller than that of the resonance cavity.

15. The mobile phone of claim 14, wherein the resonance cavity is column-shaped, the channel extending laterally from a cylinder of the resonance cavity.
